(19) United States
(12) Patent Application Publication
(10) Pub. No.: US 2025/0013589 A1
(43) Pub. Date: Jan. 9, 2025

(54) MICROELECTROMECHANICAL SYSTEMS (MEMS) SWITCH-BASED INTERFACES

(71) Applicant: Micron Technology, Inc., Boise, ID (US)

(72) Inventors: Ming-ta Hsieh, Woodbury, MN (US); Neil Petrie, St. Louis Park, MN (US); Gregory A. King, Mankato, MN (US)

(21) Appl. No.: 18/764,965

(22) Filed: Jul. 5, 2024

Related U.S. Application Data
(60) Provisional application No. 63/525,607, filed on Jul. 7, 2023.

(51) Int. Cl. G06F 13/20; H01H 1/00

(52) U.S. Cl. CPC G06F 13/20; H01H 1/0036; G06F 2213/40

(57) ABSTRACT

An interface, such as an input/output expander (IOE), includes microelectromechanical (MEMS) switches that are operable to connect or disconnect respective signal lines on the interface. MEMS switches may be less susceptible to electrostatic discharge (ESD) damages, which eliminates a need for ESD protection circuits for each MEMS switch. The interface can have improved performance due to the eliminated need for the ESD protection circuits, which otherwise may have introduced jitter in signal propagation.

### TECHNICAL FIELD

This application claims the benefit of U.S. Provisional Application No. 63/525,607, filed on Jul. 7, 2023, the contents of which are incorporated herein by reference.

The present disclosure relates generally to semiconductor memory and methods, and more particularly, to apparatuses, systems, and methods for microelectromechanical systems (MEMS) switch-based interfaces.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a block diagram of an apparatus in the form of a computing system including hosts, memory devices, and an interface coupled between the host and the memory devices in accordance with a number of embodiments of the present disclosure.

FIG. 2 is a block diagram illustrating an example input/output expander (IOE) device including MEMS switches located on signal lines on front and/or back ends of the IOE in accordance with a number of embodiments of the present disclosure.

FIG. 3 is a block diagram illustrating another example IOE including MEMS switches located on signal lines on front and/or back ends of the IOE in accordance with a number of embodiments of the present disclosure.

FIG. 4 is a block diagram illustrating another example IOE including MEMS switches located on signal lines on front and/or back ends of the IOE in accordance with a number of embodiments of the present disclosure.

FIG. 5 is a block diagram illustrating another example IOE including MEMS switches located on signal lines on front and/or back ends of the IOE in accordance with a number of embodiments of the present disclosure.

FIG. 6 is a block diagram illustrating another example IOE including MEMS switches located on signal lines on front and/or back ends of the IOE in accordance with a number of embodiments of the present disclosure.

FIG. 7 is a flow diagram of a method for controlling electromechanical switches on I/O components in accordance with a number of embodiments of the present disclosure.

### DETAILED DESCRIPTION

Systems, apparatuses, and methods related to microelectromechanical systems (MEMS) switch-based interfaces are described. An input/output expander (IOE) is a device that can be used to increase/expand the quantity of input/output (IO) pins of a device such as a controller. IOEs can be used, for example, to increase the quantity of memory devices and/or memory channels accessible via a particular IO input pin. Various prior IOEs utilize various analog circuitry (e.g., analog receivers, drivers, multiplexing circuitry, etc.) between the IOE input and output pins. Such analog circuitry can be implemented via CMOS logic (e.g., CMOS switches) and can be susceptible to noise (e.g., jitter) and electrostatic discharge (ESD) loading, for example, which can reduce signal quality. As used herein, ESD refers to the sudden flow of current between two electrically charged objects (e.g., electrical components, circuits, etc.) caused by direct contact or close proximity. To protect against ESD damage, ESD protection circuits can be added to an IOE, such as to each CMOS switch. These circuits provide a low impedance path for ESD current to flow to ground, protecting the CMOS switches from being damaged.

Performance and/or capacity of IOE can be degraded due to CMOS switch limitations. For example, parasitic capacitance on CMOS switches as well as on ESD protection circuits may introduce jitter into the signal, which can further cause delays in signal propagation, reducing the data transfer rate, etc. Further, due to the volumes exhausted by ESD protection circuits, the number of expanded memory channels that can be supported by IOEs can be limited.

Aspects of the present disclosure address the above and other challenges associated with analog circuitry that is, for example, implemented via CMOS logic. Electromechanical switches, such as MEMS switches, can be implemented and placed on those signal lines in replacement of CMOS switches, which further eliminates a need for having other circuits, components, etc. of the analog circuitry (e.g., analog receivers, drivers, multiplexing circuitry, etc.). MEMS switches can include mechanical parts that can “physically” move in response to electrical signals, allowing them to open or close MEMS switches. Accordingly, signal lines that can be connected or disconnected via MEMS switches can be “physically” connected or disconnected, which further respectively “electrically” connect or disconnect signal lines.

To control the flow of electrical signals, MEMS switches rely on mechanical parts that are less likely to be affected by electrical surges, rather than solely relying on electronic components like CMOS switches do. Therefore, MEMS switches can be less sensitive to ESD damage than CMOS switches, which eliminates a need for ESD protection circuits that would have been provided to CMOS switches. Absent parasitic capacitance (that would have been introduced by CMOS switches as well as ESD protection circuits) that would have interfered with the operation of the IOE as mentioned above, MEMS switches can improve performance of IOEs (e.g., signal propagation, the data transfer rate, etc.), Further, this provides more flexibility in structural design of IOEs by eliminating ESD protection circuits that otherwise would have exhausted substantial portion of the volume.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

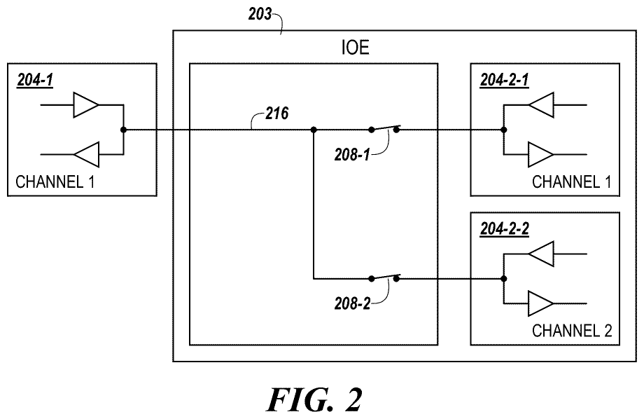

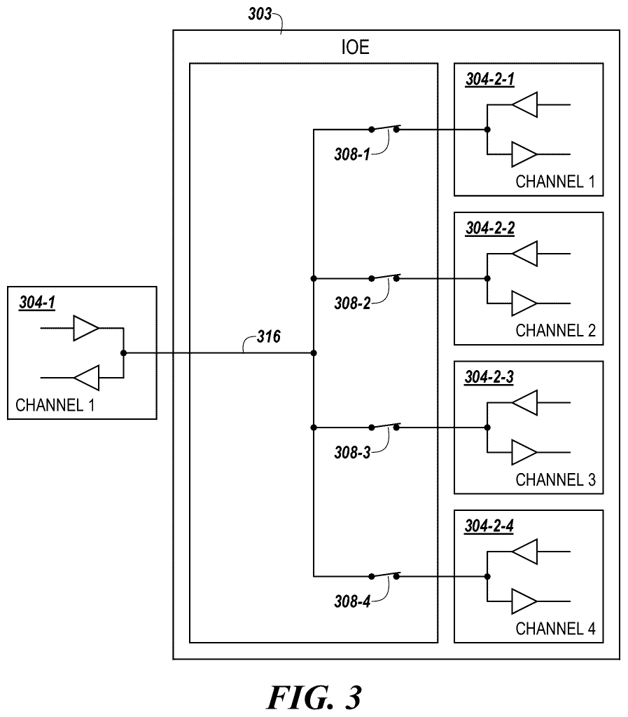

The figures herein follow a numbering convention in which the first digit or digits correspond to the drawing figure number and the remaining digits identify an element or component in the drawing. Similar elements or components between different figures may be identified by the use of similar digits. For example, 208 may reference element “08” in FIG. 2, and a similar element may be referenced as 308 in FIG. 3.

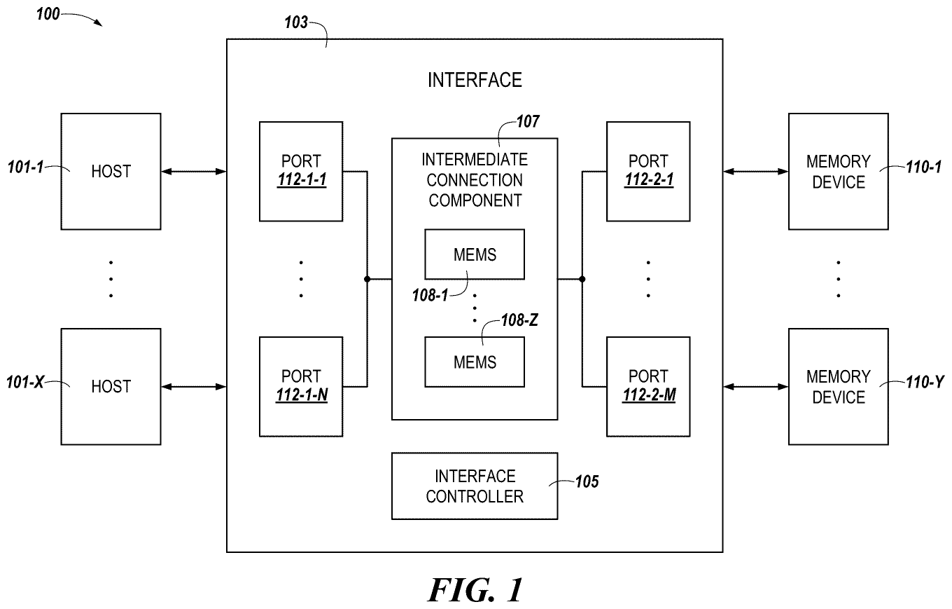

Analogous elements within a Figure may be referenced with a hyphen and extra numeral or letter. See, for example, elements 112-1, . . . , 112-N in FIG. 1. Such analogous elements may be generally referenced without the hyphen and extra numeral or letter. For example, elements 112-1, . . . , 112-N may be collectively referenced as 112. As used herein, the designators “N”, “M”, “X”, “Y”, and “Z”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a computing system 100 including hosts 101-1, . . . , 101-X (collectively referred to as “hosts 101”), memory devices 110-1, . . . , 110-Y (collectively referred to as “memory devices 110”), and an interface 103 coupled between the host and the memory devices in accordance with a number of embodiments of the present disclosure. As used herein, a host 101, an interface 103, and a memory device 110 might also be separately considered an “apparatus.”

The hosts 101 can be a computing device such as a desktop computer, laptop computer, network server, mobile device, or such computing device that includes a memory and a processing device. The hosts 101 can further, or alternatively, be a system controller to perform operations such as reading data, writing data, or erasing data at the memory devices 110 and other such operations. The host 101, as a system controller, can include a microcontroller, special purpose logic circuitry (e.g., a field programmable gate array (FPGA), an application specific integrated circuit (ASIC), etc.), or other suitable processing circuitry to perform the operations described herein.

The memory devices 110 can include any combination of the different types of non-volatile memory devices and/or volatile memory devices. Some examples of volatile memory devices include, but are not limited to, random access memory (RAM), such as dynamic random access memory (DRAM) and synchronous dynamic random access memory (SDRAM). Some examples of non-volatile memory devices include, but are not limited to, negative-and (NAND) type flash memory and write-in-place memory, such as a three-dimensional cross-point (“3D cross-point”) memory device. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the memory devices 110 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 110 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 110 can be grouped as pages that can refer to a logical unit of the memory device used to store data. With some types of memory (e.g., NAND), pages can be grouped to form blocks.

Although non-volatile memory components such as 3D cross-point are described, the memory device 110 can be based on any other type of non-volatile memory or storage device, such as negative-and (NAND), read-only memory (ROM), phase change memory (PCM), self-selecting memory, other chalcogenide based memories, ferroelectric random access memory (FeRAM), magneto random access memory (MRAM), negative-or (NOR) flash memory, and electrically erasable programmable read-only memory (EEPROM).

The hosts 101 can be coupled to the memory devices 110 via an interface 103 (alternatively referred to as “host interface”). In some embodiments, the interface 103 can be (e.g., integrated) part of one or more hosts 101. The interface 103 can be utilized to communicate data, address, command, etc. among hosts 101 and memory devices 110. Examples of a host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a dual in-line memory module (DIMM) interface (e.g., DIMM socket interface that supports Double Data Rate (DDR)), Open NAND Flash Interface (ONFI), etc. The host interface can be used to transmit data between the hosts 101 and the memory devices 110. The hosts 101 can further utilize an NVM Express (NVMe) interface to access the memory devices 110 by the PCIe interface. The host interface can provide an interface for passing control, address, data, and other signals between the memory devices 110 and the hosts 101. In some embodiments, the interface 103 can be or include an IOE device.

As used herein, the host side (to which hosts 101 can be coupled) of the interface 103 can be referred to as a front end and the memory side (to which memory devices 110 can be coupled) of the interface 103 can be referred to as a back end. The interface 103 can include a number of ports 112-1-1, . . . , 112-1-N (collectively referred to as “ports 112-1”) on the front end and a number of ports 112-2-1, . . . , 112-2-M (collectively referred to as “ports 112-2)” on the back end. The hosts 101 can be coupled to those ports 112-1-1, . . . , 112-1-N on a front end and memory devices 110 can be coupled to those ports 112-2-1, . . . , 112-2-M on a back end to communicate commands (e.g., read, write, erase, program, etc.), addresses, data, etc. between the two devices.

One or more ports 112 can respectively include one or more I/O components (simply referred to as “I/Os”), such as I/Os 204, 304, 404, 504, 604 illustrated in FIGS. 2-6. As illustrated further in connection with FIGS. 2-6, the front end ports 112-1 and the back end ports 112-2 of an IOE can be asymmetrical. For example, ports 112-2 on a back end can include I/Os. Ports 112-1 on a front end may not include I/Os, but can be coupled to one or more (e.g., integrated) I/Os of hosts 101. I/Os can include various circuitry to facilitate transmission of signals. For example, as further illustrated in FIGS. 2-6, I/Os can include one or more signal lines, transceivers (e.g., transmitter, receiver, etc.), I/O pads, etc. that can receive an external signal and/or output the received signal.

I/Os of Ports 112 can be unidirectional I/Os, bidirectional I/Os, or combination thereof. I/Os of the ports 112 can form respective buses (e.g., data buses, address buses, command buses, etc.) to receive and/or output various signals, such as those signals as defined by interface protocols (e.g., ONFI-defined signals), signals indicative of data (e.g., host data originally received from the host 101), etc. In addition to ports 112, I/Os can be placed in various locations of the computing system 100 other than ports (e.g., ports 112). For example, I/Os can be placed between peripheral devices (e.g., sensors, actuators, displays, etc.) and components of the computing system 100, and/or implemented as part of buses within the hosts 101 and/or memory devices 110, etc.

Ports 112-1 on a front end and ports 112-2 on a back end can be coupled to each other via an intermediate connection component 107. Although embodiments are not so limited, the intermediate connection component 107 can include signal lines (e.g., signal lines 216, 316, 416, 516, and/or 616 illustrated in FIGS. 2-6, respectively) coupled between ports 112, electromechanical switches 108-1, . . . , 108-Z (respectively shown as “MEMS” switches in FIG. 1) that can be respectively located at the signal lines. The intermediate connection component 107 can include circuitry configured to functionally operate as a multiplexor and/or demultiplexor to provide selective coupling between ports 112-1 and ports 112-2.

The interface 103 can include an interface controller 105 communicatively coupled to the hosts 101, memory devices 110, and intermediate connection component 107. The interface controller 105 can be configured to control flow of commands and/or data between one or more hosts 101 and the memory devices 110 as instructed by the hosts 101 and/or the memory devices 110. For example, in response to receipt of commands from the hosts 101 and/or the memory devices 110, the interface controller 105 can dynamically configure topology between ports 112-1 (e.g., on a front end) and ports 112-2 (e.g., on a back end) to selectively couple the ports 112-1 to the ports 112-2. The interface controller 105 can include various circuitry to facilitate an operation described herein, such as controlling various parts (e.g., electromechanical switches 108) of intermediate connection component 107. For example, the interface controller 105 can include special purpose circuitry in the form of an ASIC, FPGA, state machine, and/or other logic circuitry or software and/or firmware that can allow the interface controller 105 to control electromechanical switches 108.

The interface controller 105 can configure/reconfigure the topology by enabling/disabling electromechanical switches 108 on the intermediate connection component 107. As used herein, “disabling” electromechanical switches refers to placing electromechanical switches in an open position, while “enabling” electromechanical switches refers to placing switches in a “closed” position. Those switches that are in an “open” position disconnect respective signal lines (e.g., signal lines on which the switches are located), while those switches that are in a “closed” position connect respective signal lines. Accordingly, two components (e.g., hosts 101 and memory devices 110) that are coupled to each other via “connected” signal lines are also “connected”, while two components that are coupled to each other via “disconnected” signal lines are also “disconnected”. As described herein, MEMS switches can include mechanical parts that can “physically” move between a closed and an open position, which can provide both electrical and physical isolation when open.

In some embodiments, a single host 101 can be coupled to multiple ports 112-1 to establish multiple “channels” between the host 101 and memory devices 110. In this example, multiple ports 112-1 coupled to the same host 101 can respectively be operated to transmit different types of signals (e.g., DQ signals, ONFI-defined signals, etc.). In some embodiments, one port 112-1 can be used to transmit differential clock signals to synchronize operation of multiple memory devices 110 particular when coupled to the same host 101.

FIG. 2 is a block diagram illustrating an example IOE 203 including MEMS switches 208-1, 208-2 (collectively referred to as MEMS switches 208) located on signal lines on front and/or back ends of the IOE 203 in accordance with a number of embodiments of the present disclosure. The back end I/Os 204-2-1 and 204-2-2 can be collectively referred to as “I/Os 204-2”. An IOE 203 can be analogous to and/or be part of the interface 103 illustrated in FIG. 1. Further, I/Os 204 can be analogous to I/Os 104 illustrated in FIG. 1.

Each I/O 204-2 can correspond to and/or represent a port (e.g., port 112-2 illustrated in FIG. 1). As described herein, the front end ports (e.g., a port that is coupled or couplable to I/O 204-1) can be coupled to a host (e.g., host 101 illustrated in FIG. 1), while those ports (e.g., ports respectively corresponding to I/Os 204-2-1 and 204-2-2) can be coupled to memory devices (e.g., memory devices 110 illustrated in FIG. 1).

MEMS switches 208-1 and 208-2 can respectively and selectively connect or disconnect signal lines coupled to I/Os 204-2-1 and 204-2-1 to further selectively connect I/O 204-1 to or disconnect I/O 204-1 from I/Os 204-2-1 and 204-2-2. For example, a MEMS switch 208-1 can be placed in a closed position to connect I/O 204-1 to or in an open position to disconnect I/O 204-1 from I/O 204-2-1, and a MEMS switch 208-2 can be placed in a closed position to connect I/O 204-1 to or in an open position to disconnect I/O 204-1 from I/O 204-2-2.

IOE approaches that utilize various CMOS logic (e.g., switches) in the form of logic gates and multiplexing/demultiplexing circuitry can have drawbacks such as relatively high parasitic capacitance and susceptibility to noise/jitter, for example, which can limit the IOE's data transfer bandwidth and/or available quantity of expanded memory channels, among other drawbacks as compared to IOE embodiments of the present disclosure. In contrast, IOE embodiments of the present disclosure with MEMS switches (e.g., MEMS switches 208) are substantially less susceptible to electrostatic discharge than CMOS switches are, which eliminates a need for a separate ESD protection circuit for MEMS switches. For example, a parasitic capacitance associated with each MEMS switch 208 is lower than a threshold such that the MEMS switch 208 is configured to selectively connect/disconnect a respective signal line 216 in the absence of a separate ESD protection circuit coupled thereto. Therefore, although IOE 203 may include further circuitry that are not illustrated in FIG. 2, IOE 203 may not include various ESD protection circuit typically required in previous IOE approaches that utilize various CMOS logic (e.g., switches) such that IOE 203 does not impose significant bandwidth limitations that are typically introduced by previous IOE approaches.

FIG. 3 is a block diagram illustrating another example IOE 303 device including MEMS switches 308-1, 308-2, 308-3, 308-4 (collectively referred to as MEMS switches 308) located on signal lines on front and/or back ends of the IOE 303 in accordance with a number of embodiments of the present disclosure. The back end I/Os 304-2-1, . . . , 304-2-4 on a back end can be collectively referred to as “I/Os 304-2”. An IOE 303 can be analogous to and/or be part of the interface 103 illustrated in FIG. 1. Further, I/Os 304 can be analogous to I/Os 104 illustrated in FIG. 1.

Each I/O 304-2 can correspond and/or represent a port (e.g., port 112-2 illustrated in FIG. 1). As described herein, the front end ports (e.g., a port that is coupled or couplable to I/O 304-1) can be coupled to one or more hosts (e.g., hosts 101 illustrated in FIG. 1), while those ports (e.g., ports respectively corresponding to I/Os 304-2-1, . . . , 304-2-4) can be coupled to memory devices (e.g., memory devices 110 illustrated in FIG. 1).

The IOE 303 includes a signal line 316, which is coupled to (e.g., an I/O pad of) I/O 304-1 one end and is diverted to four different signal lines that are respectively coupled to (e.g., respective I/O pads) of I/Os 304-2-1, . . . , 304-2-4 on the other end. As further illustrated in FIG. 3, MEMS switches 308-1, . . . , 308-4 are located respectively on the four signal lines.

MEMS switches 308-1, . . . , 308-4 can respectively and selectively connect or disconnect signal lines coupled to I/Os 304-2-1, . . . , 304-2-4 to further selectively connect (e.g., connect) I/O 304-1 to or disconnect I/O 304-1 from I/Os 304-2-1, . . . , 304-2-4, respectively. For example, a MEMS switch 308-1 can be placed in a closed position to connect I/O 304-1 to or in an open position to disconnect I/O 304-1 from I/O 304-2-1; a MEMS switch 308-2 can be placed in a closed position to connect I/O 304-1 to or in an open position to disconnect I/O 304-1 from I/O 304-2-2; a MEMS switch 308-3 can be placed in a closed position to connect I/O 304-1 to or in an open position to disconnect I/O 304-1 from I/O 304-2-3; and a MEMS switch 308-4 can be placed in a closed position to connect I/O 304-1 to or in an open position to disconnect I/O 304-1 from I/O 304-2-4.

IOE approaches that utilize various CMOS logic (e.g., switches) in the form of logic gates and multiplexing/demultiplexing circuitry can have drawbacks such as relatively high parasitic capacitance and susceptibility to noise/jitter, for example, which can limit the IOE's data transfer bandwidth and/or available quantity of expanded memory channels, among other drawbacks as compared to IOE embodiments of the present disclosure. In contrast, IOE embodiments of the present disclosure with MEMS switches (e.g., MEMS switches 308) are substantially less susceptible to electrostatic discharge than CMOS switches are, which eliminates a need for a separate ESD protection circuit for MEMS switches. For example, a parasitic capacitance associated with each MEMS switch 308 is lower than a threshold such that the MEMS switch 308 is configured to selectively connect/disconnect a respective signal line 316 in the absence of a separate ESD protection circuit coupled thereto. Therefore, although IOE 303 may include further circuitry that are not illustrated in FIG. 3, IOE 303 may not include various ESD protection circuit typically required in previous IOE approaches that utilize various CMOS logic (e.g., switches) such that IOE 303 does not impose significant bandwidth limitations that are typically introduced by previous IOE approaches.

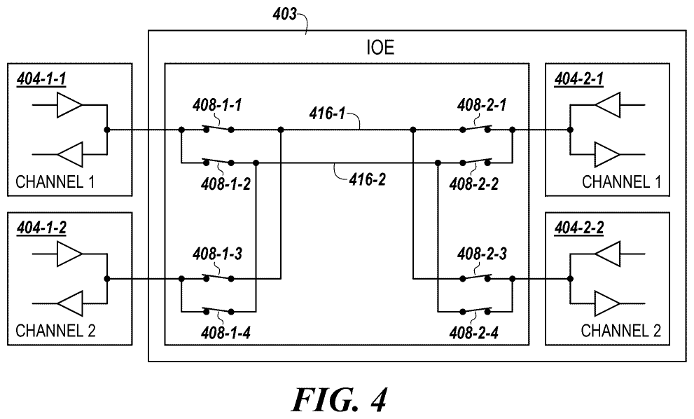

FIG. 4 is a block diagram illustrating another example IOE including MEMS switches 408-1-1, 408-1-2, 408-2-1, 408-2-2 (collectively referred to as MEMS switches 408) located on signal lines on front and/or back ends of the IOE 403 in accordance with a number of embodiments of the present disclosure. The front end I/Os 404-1-1 and 404-1-2 can be collectively referred to as “I/Os 404-1”, while the back end I/Os 404-2-1 and 404-2-2 can be collectively referred to as “I/Os 404-2”. An IOE 403 can be analogous to and/or be part of the interface 103 illustrated in FIG. 1. Further, I/Os 404 can be analogous to I/Os 104 illustrated in FIG. 1.

Each I/O 404 can correspond and/or represent a port (e.g., port 112-2 illustrated in FIG. 1). As described herein, those ports (e.g., ports that are respectively coupled or couplable to I/Os 404-1-1 and 404-1-2) can be coupled to hosts (e.g., hosts 101 illustrated in FIG. 1), while those ports (e.g., ports respectively corresponding to I/Os 404-2-1 and 404-2-2) can be coupled to memory devices (e.g., memory devices 110 illustrated in FIG. 1).

The IOE 403 includes signal lines 416-1 and 416-2. Each signal line 416 is diverted on one end to two different signal lines that are respectively coupled to (e.g., respective I/O pads) of I/Os 404-1-1 and 404-1-2 and further diverted on the other end to two different signal lines that are respectively coupled to (e.g., respective I/O pads) of I/Os 404-2-1 and 404-2-2. As further illustrated in FIG. 4, MEMS switches 408-1-1 and 408-1-2 are located on the two diverted signal lines coupled to an I/O pad of I/O 404-1-1; MEMS switches 408-1-3 and 408-1-4 are located on the two diverted signal lines coupled to an I/O pad of I/O 404-1-2; MEMS switches 408-2-1 and 408-2-2 are located on the two diverted signal lines coupled to an I/O pad of I/O 404-2-1; and MEMS switches 408-2-3 and 408-2-4 are located on the two diverted signal lines coupled to an I/O pad of I/O 404-2-2.

The IOE 403 can allow various/flexible topologies, in which I/Os 404-1 (e.g., I/Os 404-1-1 and 404-1-2) can be selectively connected to I/Os 404-2 (e.g., I/Os 404-2-1 and 404-2-2). In one example, I/O 404-1-1 can be connected to both I/Os 404-2-1 and 404-2-2. Vice versa, I/O 404-1-2 can be connected to both I/Os 404-2-1 and 404-2-2. In another example, I/O 404-1-1 can be connected to one I/O 404-2 (e.g., 404-2-1) via a signal line 416-1, while I/O 404-1-2 can be connected to another I/O 404-2 (e.g., 404-2-2) via a signal line 416-2 (e.g., without leaving a single one of I/Os 404-1 disconnected). In this example, MEMS switches 408-1-1, 408-1-4, 408-2-1, and 408-2-4 can be placed in a closed position, while MEMS switches 408-1-2, 408-1-3, 408-2-2, and 408-2-3 can be placed in an open position.

IOE approaches that utilize various CMOS logic (e.g., switches) in the form of logic gates and multiplexing/demultiplexing circuitry can have drawbacks such as relatively high parasitic capacitance and susceptibility to noise/jitter, for example, which can limit the IOE's data transfer bandwidth and/or available quantity of expanded memory channels, among other drawbacks as compared to IOE embodiments of the present disclosure. In contrast, IOE embodiments of the present disclosure with MEMS switches (e.g., MEMS switches 408) are substantially less susceptible to electrostatic discharge than CMOS switches are, which eliminates a need for a separate ESD protection circuit for MEMS switches. For example, a parasitic capacitance associated with each MEMS switch 408 is lower than a threshold such that the MEMS switch 408 is configured to selectively connect/disconnect a respective signal line 416 in the absence of a separate ESD protection circuit coupled thereto. Therefore, although IOE 403 may include further circuitry that are not illustrated in FIG. 4, IOE 403 may not include various ESD protection circuit typically required in previous IOE approaches that utilize various CMOS logic (e.g., switches) such that IOE 403 does not impose significant bandwidth limitations that are typically introduced by previous IOE approaches.

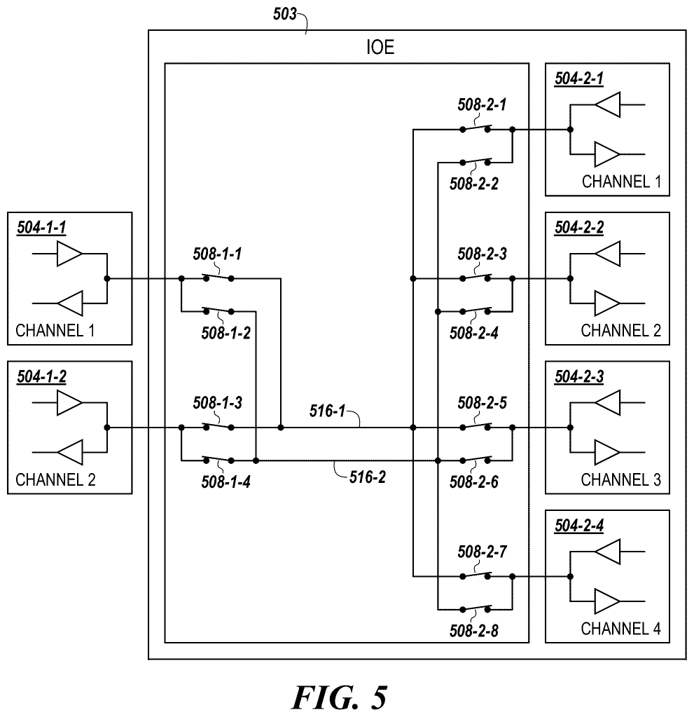

FIG. 5 is a block diagram illustrating another example IOE 503 including MEMS switches 508-1-1, . . . , 508-1-4 and 508-2-1, . . . , 508-2-8 (collectively referred to as MEMS switches 508) located on signal lines on front and/or back ends of the IOE 503 in accordance with a number of embodiments of the present disclosure. The front end I/Os 504-1-1 and 504-1-2 can be collectively referred to as “I/Os 504-1”, while the back end I/Os 504-2-1, . . . , 504-2-4 can be collectively referred to as “I/Os 504-2”. An IOE 503 can be analogous to and/or be part of the interface 103 illustrated in FIG. 1. Further, I/Os 504 can be analogous to I/Os 104 illustrated in FIG. 1.

Each I/O 504-2 can correspond and/or represent a port (e.g., port 112-2 illustrated in FIG. 1). As described herein, those ports (e.g., ports that are respectively coupled or couplable to I/Os 504-1-1 and 504-1-2) can be coupled to hosts (e.g., hosts 101 illustrated in FIG. 1), while those ports (e.g., ports respectively corresponding to I/Os 504-2-1, 504-2-2, 504-2-3, and 504-2-4) can be coupled to memory devices (e.g., memory devices 110 illustrated in FIG. 1).

The IOE 503 includes signal lines 516-1 and 516-2. Each signal line 516 is diverted on one end to two different signal lines that are respectively coupled to (e.g., respective I/O pads) of I/Os 504-1-1 and 504-1-2 and further diverted on the other end to two different signal lines that are respectively coupled to (e.g., respective I/O pads) of I/Os 504-2-1, 504-2-2, 504-2-3, and 504-2-4.

As further illustrated in FIG. 5, MEMS switches 508-1-1 and 508-1-2 are located on the two diverted signal lines coupled to an I/O pad of I/O 504-1-1; MEMS switches 508-1-3 and 508-1-4 are located on the two diverted signal lines coupled to an I/O pad of I/O 504-1-2; MEMS switches 508-2-1 and 508-2-2 are located on the two diverted signal lines coupled to an I/O pad of I/O 504-2-1; MEMS switches 508-2-3 and 508-2-4 are located on the two diverted signal lines coupled to an I/O pad of I/O 504-2-2; MEMS switches 508-2-5 and 508-2-6 are located on the two diverted signal lines coupled to an I/O pad of I/O 504-2-3; and MEMS switches 508-2-7 and 508-2-8 are located on the two diverted signal lines coupled to an I/O pad of I/O 504-2-4.

The IOE 503 can allow various/flexible topologies, in which I/Os 504-1 (e.g., I/Os 504-1-1 and 504-1-2) can be selectively connected to I/Os 504-2 (e.g., I/Os 504-2-1, . . . , 504-2-4). In one example, I/O 504-1-1 can be connected to four I/Os 504-2-1, . . . , 504-2-4. Vice versa, I/O 504-1-2 can be connected to four I/Os 504-2-1, . . . , 504-2-4. In another example, I/O 504-1-1 can be connected to a first portion of I/Os 504-2 (e.g., 504-2-1 and 504-2-2) via a signal line 516-1, while I/O 504-1-2 can be connected to a second portion of I/O 504-2 (e.g., 504-2-3 and 504-2-4) via a signal line 516-2 (e.g., without leaving a single one of I/Os 404-1 disconnected). In this example, MEMS switches 508-1-1, 508-1-4, 508-2-1, 508-2-3, 508-2-6, and 508-2-8 can be placed in a closed position, while MEMS switches 508-1-2, 508-1-3, 508-2-2, 508-2-4, 508-2-5, and 508-2-7 can be placed in an open position.

IOE approaches that utilize various CMOS logic (e.g., switches) in the form of logic gates and multiplexing/demultiplexing circuitry can have drawbacks such as relatively high parasitic capacitance and susceptibility to noise/jitter, for example, which can limit the IOE's data transfer bandwidth and/or available quantity of expanded memory channels, among other drawbacks as compared to IOE embodiments of the present disclosure. In contrast, IOE embodiments of the present disclosure with MEMS switches (e.g., MEMS switches 508) are substantially less susceptible to electrostatic discharge than CMOS switches are, which eliminates a need for a separate ESD protection circuit for MEMS switches. For example, a parasitic capacitance associated with each MEMS switch 508 is lower than a threshold such that the MEMS switch 508 is configured to selectively connect/disconnect a respective signal line 516 in the absence of a separate ESD protection circuit coupled thereto. Therefore, although IOE 503 may include further circuitry that are not illustrated in FIG. 5, IOE 503 may not include various ESD protection circuit typically required in previous IOE approaches that utilize various CMOS logic (e.g., switches) such that IOE 503 does not impose significant bandwidth limitations that are typically introduced by previous IOE approaches.

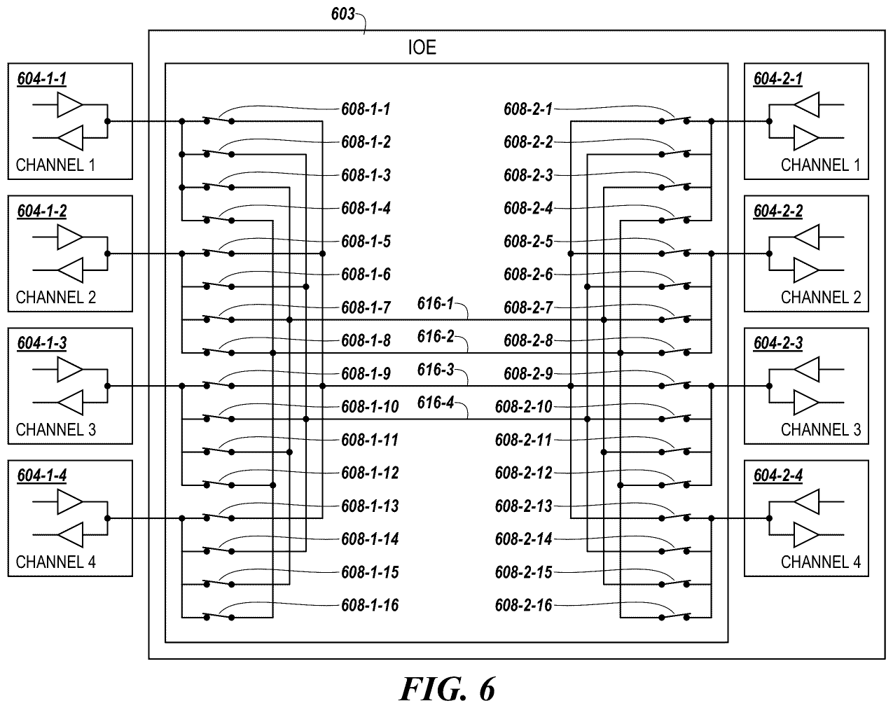

FIG. 6 is a block diagram illustrating another example IOE 603 including MEMS switches 608-1-1, . . . , 608-1-16 and 608-2-1, . . . , 608-2-16 (collectively referred to as MEMS switches 608) located on signal lines on front and/or back ends of the IOE 603 in accordance with a number of embodiments of the present disclosure. The front end I/Os 604-1-1, . . . , 604-1-4 can be collectively referred to as “I/Os 604-1”, while the back end I/Os 604-2-1, . . . , 604-2-4 can be collectively referred to as “I/Os 604-2”. An IOE 603 can be analogous to and/or be part of the interface 103 illustrated in FIG. 1. Further, I/Os 604 can be analogous to I/Os 104 illustrated in FIG. 1.

Each I/O 604-2 can correspond and/or represent a port (e.g., port 112-2 illustrated in FIG. 1). As described herein, those ports (e.g., ports that are respectively coupled or couplable to I/Os 604-1-1, . . . , 604-1-4) can be coupled to hosts (e.g., hosts 101 illustrated in FIG. 1), while those ports (e.g., ports respectively corresponding to I/Os 604-2-1, . . . , 604-2-4) can be coupled to memory devices (e.g., memory devices 110 illustrated in FIG. 1).

The IOE 603 includes signal lines 616-1, . . . , 616-4. Each signal line 616 is diverted on one end to four different signal lines that are respectively coupled to (e.g., respective I/O pads) of I/Os 604-1-1 and 604-1-2 and further diverted on the other end to four different signal lines that are respectively coupled to (e.g., respective I/O pads) of I/Os 604-2-1, 604-2-2, 604-2-3, and 604-2-4.

As further illustrated in FIG. 6, MEMS switches 608-1-1, . . . , 608-1-4 are located on the two diverted signal lines coupled to an I/O pad of I/O 604-1-1; MEMS switches 608-1-5, . . . , 608-1-8 are located on the two diverted signal lines coupled to an I/O pad of I/O 604-1-2; MEMS switches 608-1-9, . . . , 608-1-12 are located on the two diverted signal lines coupled to an I/O pad of I/O 604-1-3; MEMS switches 608-1-13, . . . , 608-1-16 are located on the two diverted signal lines coupled to an I/O pad of I/O 604-1-4; MEMS switches 608-2-1, . . . , 608-2-4 are located on the two diverted signal lines coupled to an I/O pad of I/O 604-2-1; MEMS switches 608-2-5, . . . , 608-2-8 are located on the two diverted signal lines coupled to an I/O pad of I/O 604-2-2; MEMS switches 608-2-9, . . . , 608-2-12 are located on the two diverted signal lines coupled to an I/O pad of I/O 604-2-3; and MEMS switches 608-2-13, . . . , 608-2-16 are located on the two diverted signal lines coupled to an I/O pad of I/O 604-2-4.

The IOE 603 can allow various/flexible topologies, in which I/Os 604-1 (e.g., I/Os 604-1-1 and 604-1-2) can be selectively connected to I/Os 604-2 (e.g., I/Os 604-2-1 and 604-2-2). In one example, one I/O 604-1 can be connected to four I/Os 604-2-1, . . . , 604-2-4.

By having a quantity of signal lines (that are coupled to each I/Os 604) corresponding to a quantity of I/Os 604 on a front or back end, each I/O 604-1 can be simultaneously connected to a different I/O 604-2 without leaving a single one of I/Os 604-1 disconnected. For example, I/Os 604-1-1 can be connected to I/O 604-2-1 via a signal line 616-1; I/Os 604-1-2 can be connected to I/O 604-2-2 via a signal line 616-2; I/Os 604-1-3 can be connected to I/O 604-2-3 via a signal line 616-3; and I/Os 604-1-4 can be connected to I/O 604-2-4 via a signal line 616-4, although embodiments are not so limited. In this example, MEMS switches 608-1-1, 608-1-6, 608-1-11, 608-1-16 as well as MEMS switches 608-2-1, 608-2-6, 608-2-11, 608-2-16 can be placed in a closed position, while the other MEMS switches 608-1 and 608-2 are placed in an open position.

IOE approaches that utilize various CMOS logic (e.g., switches) in the form of logic gates and multiplexing/demultiplexing circuitry can have drawbacks such as relatively high parasitic capacitance and susceptibility to noise/jitter, for example, which can limit the IOE's data transfer bandwidth and/or available quantity of expanded memory channels, among other drawbacks as compared to IOE embodiments of the present disclosure. In contrast, IOE embodiments of the present disclosure with MEMS switches (e.g., MEMS switches 608) are substantially less susceptible to electrostatic discharge than CMOS switches are, which eliminates a need for a separate ESD protection circuit for MEMS switches. For example, a parasitic capacitance associated with each MEMS switch 608 is lower than a threshold such that the MEMS switch 608 is configured to selectively connect/disconnect a respective signal line 616 in the absence of a separate ESD protection circuit coupled thereto. Therefore, although IOE 603 may include further circuitry that are not illustrated in FIG. 6, IOE 603 may not include various ESD protection circuit typically required in previous IOE approaches that utilize various CMOS logic (e.g., switches) such that IOE 603 does not impose significant bandwidth limitations that are typically introduced by previous IOE approaches.

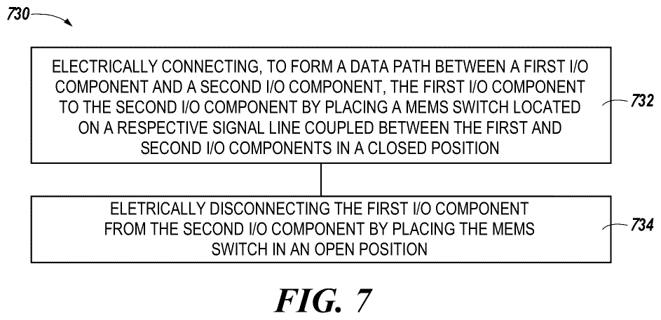

FIG. 7 is a flow diagram 730 of a method for controlling electromechanical switches on I/O components in accordance with a number of embodiments of the present disclosure. The method as illustrated by the flow diagram 730 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by controller 105 illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 732, a data path between a first I/O component (e.g., I/O component 204-1, 304-1, 404-1, 504-1, 604-1) and a second I/O component (e.g., I/O component 204-2, 304-2, 404-2, 504-2, 604-2 illustrated in FIGS. 2-6) can be formed by electrically connecting the first I/O component 204-1, 304-1, 404-1, 504-1, 604-1 to the second I/O component 204-2, 304-2, 404-2, 504-2, 604-2 by placing a MEMS switch (e.g., MEMS switch 108, 208, 308, 408, 508, 608 illustrated in FIGS. 1-6) located on a respective signal line (e.g., signal line 216, 316, 416, 516, 616 illustrated in FIGS. 2-6) coupled between the first and second I/O components in a closed position. At 734, the first I/O component 204-1, 304-1, 404-1, 504-1, 604-1 can be electrically disconnected from the second I/O component 204-2, 304-2, 404-2, 504-2, 604-2 by placing the MEMS switch 108, 208, 308, 408, 508, 608 in an open position.

In some embodiments, the second I/O component 204-2, 304-2, 404-2, 504-2, 604-2 can be one of a number of second I/O components (e.g., I/O components 204-2, 304-2, 404-2, 504-2, 604-2 illustrated in FIGS. 2-6) coupled to the first I/O component 204-1, 304-1, 404-1, 504-1, 604-1 via a respective number of signal lines (e.g., signal lines 216, 316, 416, 516, 616 illustrated in FIGS. 2-6). In this example, a data path between the first I/O component 204-1, 304-1, 404-1, 504-1, 604-1 and a first portion of the number of second I/O components 204-2, 304-2, 404-2, 504-2, 604-2 can be selectively formed by placing one or more MEMS switches 108, 208, 308, 408, 508, 608 located on respective first signal lines 216, 316, 416, 516, 616 (coupled between the first I/O component 204-1, 304-1, 404-1, 504-1, 604-1 and the first portion of the number of second I/O components 204-2, 304-2, 404-2, 504-2, 604-2) in a closed position. Further, while the first I/O component 204-1, 304-1, 404-1, 504-1, 604-1 is (e.g., electrically and selectively) connected to the first portion of the second number of I/O components 204-2, 304-2, 404-2, 504-2, 604-2, one or more MEMS switches 108, 208, 308, 408, 508, 608 located on respective second signal lines 216, 316, 416, 516, 616 (coupled between the first I/O component 204-1, 304-1, 404-1, 504-1, 604-1 and a second portion of the number of second I/O components 204-2, 304-2, 404-2, 504-2, 604-2) can be placed in an open position.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
electrically connecting, to form a data path between a first input/output (I/O) component and a second I/O component, the first I/O component to the second I/O component by placing a microelectromechanical systems (MEMS) switch located on a respective signal line coupled between the first and second I/O components in a closed position; and
electrically disconnecting the first I/O component from the second I/O component by placing the MEMS switch in an open position.

2. The method of claim 1, wherein:
the second I/O component is one of a number of second I/O components coupled to the first I/O component via a respective number of signal lines; and
the method further comprises placing, to selectively form a data path between the first I/O component and a first portion of the number of second I/O components, one or more MEMS switches located on respective first signal lines in a closed position, wherein the respective first signal lines are coupled between the first I/O component and the first portion of the number of second I/O components.

3. The method of claim 2, further comprising placing, while the first I/O component is connected to the first portion of the number of second I/O components, one or more MEMS switches located on respective second signal lines in an open position, wherein the respective second signal lines are coupled between the first I/O component and a second portion of the number of second I/O components.

4. An apparatus, comprising:
a first number of input/output (I/O) components;
a second number of I/O components; and
one or more microelectromechanical systems (MEMS) switches operable to selectively connect a first one of the first number of I/O components to two or more of the second number of I/O components via respective signal lines to which the one or more MEMS switches are coupled.

5. The apparatus of claim 4, wherein a parasitic capacitance associated with the one or more MEMS switches is lower than a threshold such that the one or more MEMS switches are configured to selectively connect the first one of the first number of I/O components to the two or more of the second number of I/O components in the absence of a separate electrostatic discharge (ESD) protection circuit coupled thereto.

6. The apparatus of claim 4, further comprising one or more additional MEMS switches operable to selectively connect a second one of the first number of I/O components to two or more of the second number of I/O components via respective signal lines to which the one or more additional MEMS switches are coupled.

7. The apparatus of claim 6, wherein the one or more MEMS switches includes at least two MEMS switches, and wherein the one or more additional MEMS switches includes at least two MEMS switches.

8. The apparatus of claim 4, wherein the apparatus comprises an I/O expander (IOE).

9. The apparatus of claim 4, wherein at least one of the first number of I/O components corresponds to a bidirectional I/O component.

10. The apparatus of claim 4, wherein the one or more MEMS switches further comprises:
a first number of microelectromechanical systems (MEMS) switches located on a first portion of the apparatus, the first number of MEMS switches coupled to a first number of signal lines and operable to respectively and selectively connect or disconnect the first number of signal lines; and
a second number of MEMS switches located on a second end portion of the apparatus, the second number of MEMS switches coupled to a second number of signal lines and operable to respectively and selectively connect or disconnect the second number of signal lines.

11. The apparatus of claim 10, wherein capacitance of each MEMS switch of the first and second number of MEMS switches is lower than a threshold such that each of the first and second MEMS switches does not include a separate electrostatic discharge (ESD) protection circuit.

12. The apparatus of claim 10, further comprising:
the first number of I/O respectively coupled to the first number of MEMS switches;
wherein the first number of MEMS switches further comprises a plurality of sets of MEMS switches, each set of MEMS switches of the plurality coupled to a respective I/O component of the first number of I/O components.

13. The apparatus of claim 12, wherein a quantity of MEMS switches of each set corresponds to a quantity of the second number of I/O components respectively couplable to the second number of MEMS switches.

14. The apparatus of claim 10, wherein a quantity of the second number of I/O components is greater than a quantity of the first number of I/O components.

15. A system, comprising:
a first number of signal lines, the first number of signal lines diverted to a second number of signal lines on a front end of an interface device and further diverted to a third number of signal lines on a back end of the interface device;
a first number of microelectromechanical systems (MEMS) switches, each MEMS switch of the first number of MEMS switch located on a respective signal line of the second number of signal lines, the first number of MEMS switches operable to respectively connect or disconnect the respective signal line of the second number of signal lines; and
a second number of MEMS switches, each MEMS switch of the second number of MEMS switch located on a respective signal line of the third number of signal lines, the second number of MEMS switches operable to respectively connect or disconnect the respective signal line of the third number of signal lines.

16. The system of claim 15, wherein the interface device further comprises a first number of input/output (I/O) components respectively coupled to the third number of signal lines.

17. The system of claim 16, further comprising:
a number of first ports on the front end; and
a number of second ports on the back end, each port of the number of second ports comprises one or more I/O components of the first number of IO components.

18. The system of claim 17, wherein:
a first portion of the second number of MEMS switches corresponds to one port of the number of second ports; and
a second portion of the second number of MEMS switches corresponds to a different port of the number of second ports.

19. The system of claim 17, wherein each port of the number of first ports is simultaneously connectable to a different port of the number of second ports without leaving a single port of the number of first ports or the number of second ports disconnected.

20. The system of claim 17, wherein:
a first portion of the first number of MEMS switches corresponds to one port of the number of first ports; and
a second portion of the first number of MEMS switches corresponds to a different port of the number of first ports.

21. The system of claim 17, wherein each port of the number of first ports on the front end is couplable to an I/O component of one or more hosts.

22. The system of claim 15, further comprising an interface controller configured to:
place a MEMS switch of the first number of MEMS switch in an open position to disconnect a respective signal line of the second number of signal lines; and
place a MEMS switch of the first number of MEMS switch in a closed position to connect a respective signal line of the second number of signal lines.

23. The system of claim 15, further comprising an interface controller configured to:
place a MEMS switch of the second number of MEMS switch in an open position to disconnect a respective signal line of the third number of signal lines; and
place a MEMS switch of the second number of MEMS switch in a closed position to connect a respective signal line of the third number of signal lines.
